(19) United States
(12) Patent Application Publication
(10) Pub. No.: US 2002/0007556 A1
(43) Pub. Date: Jan. 24, 2002

(54) Light wheel disk with large space for brake

(75) Inventors: Guy Marron, Saint Victoret (FR); Alain Sbroggio, Le Rove (FR)

Correspondence Address: SUGHRUE, MION, ZINN, MACPEAK & SEAS, PLLC, 2100 Pennsylvania Avenue, NW, Washington, DC, 20037-3213, US

(73) Assignee: USINOR

(21) Appl. No.: 09/893,500

(22) Filed: Jun. 29, 2001

(30) Foreign Application Priority Data
Jun. 30, 2000 (FR) N0008456

(51) Int. Cl. B23P 17/00

(52) U.S. Cl. 29/894.325

(57) ABSTRACT

Process for producing a motorized land vehicle wheel, in general having a wheel disk and an essentially cylindrical rim, the wheel disk being obtained from a blank plate of specific thickness subjected to several shaping operations, and composed of an essentially flat central part having an opening that serves to center and attach the wheel to the vehicle's axle hub, an essentially conical interior riser, another inverted conical part that defines, with the interior riser, a curved tip that has a large radius of curvature, the inverted conical part terminating in a flanged edge used to join the disk to the rim, a process characterized in that during the forming operation of the flanged edge, the plate is laminated in such a way as to preserve or reduce the thickness of the base plate.

The present invention concerns a process for producing a motorized land vehicle wheel.

In the production of automobile wheels, manufacturers seek to make the vehicles lighter and therefore seek to lighten all of the individual components of the automobile. Wheel manufacturers must therefore optimize the weight of the wheels, particularly as it involves a non-suspended motive unit. For safety reasons, automobile manufacturers are turning toward increasing the braking power of vehicles, which requires a larger and larger brake diameter. It is important, therefore, that for a given wheel dimension, the space available inside of the wheel disk be as large as possible.

A wheel for a motorized land vehicle in general has a wheel disk and an essentially cylindrical rim. The wheel disk is composed of an essentially flat central part having an opening that is used to center and attach the wheel to the vehicle's axle hub, an essentially conical internal riser, another inverted conical part that defines, with the internal riser, a rounded tip that has a large radius of curvature, the inverted conical part terminating in a flanged edge that connects the disk to the rim.

The elements of a motorized land vehicle wheel are generally obtained by stamping from a blank plate in one or more parts that can be joined, for example by LASER.

The various forming operations produce in the end a profile of the wheel disk generally composed of five concentric circular areas:

the central part used to attach the wheel to the vehicle's axle hub,

the essentially conical interior riser connecting the opening of the central part and the top of the wheel called rounded tip,

the rounded tip, which has a large radius of curvature,

the rear area of the rounded tip, inverted conical part, on which the lightening holes are located,

the flanged edge by which the wheel disk is generally joined to the rim.

A standard process for producing a wheel disk is generally composed of eight steps that can be broken down into four divisions:

1 step to cut the blank

2 to 3 steps for forming

1 step to cut the periphery of the stamping

1 step for the flanged edge

and several steps for cutting, such as slots, holes for mounting and sizing operations.

The blank is often composed of a plate of constant thickness. The stamping processes modify the thickness and cause localized thickening depending on the expanded or contracted areas. The edge flange operation invariably causes a significant thickening on the periphery of the disk, due to the deformation under contraction. This thickening is continuous along the flanged edge. It is usually an average of 14%.

The flanged edge of the disk provides support where the disk and rim are joined. It is also the seat of the welded bond between disk and rim. The welded joint is a seam weld, and more rarely is done by spot welding with laser.

The joining of the disk and rim is thus composed of a portion of rim and overlapping disk. This area is thus oversized because of the thickening caused by the stamping of the disk and by the overlapping of the flanged edge on the rim.

The disadvantages of this type of standard wheel are:

a relatively high weight of the disk,

the space available for the brakes inside the wheel disk is limited in size.

The purpose of the invention is to lighten the wheel, and the wheel disk in particular, and to increase the space available inside the disk for a fixed outside diameter. A purpose of the invention is also to size exactly as needed the different areas of the wheel while preserving a single grade of steel for the whole blank and a constant initial thickness of the blank.

A purpose of the invention is a process for producing a motorized land vehicle wheel having, in general, a wheel disk and an essentially cylindrical rim, the wheel disk being obtained from a blank plate of specific thickness subjected to several forming operations, and composed of an essentially flat central part having an opening used to center and attach the wheel to the vehicle's axle hub, an essentially conical interior riser, another inverted conical part defining, with the interior riser, a rounded tip that has a large radius of curvature, the inverted conical part terminating in a flanged edge designed to join the wheel with the rim, which process is characterized in that during the operation of forming the flanged edge, the plate is laminated in such a way as to preserve or reduce the thickness of the base plate.

The other characteristics of the invention are:

the plate is laminated by stamping,

the periphery of the disk is first cut to a smaller diameter in order to accommodate the overlength caused by the laminating operation, during the operation to form the flanged edge.

The invention also concerns a stamping device for motorized land vehicle wheel disk, the wheel disk being obtained from a blank plate of specific thickness subjected to several forming operations, the disk being composed of an essentially flat central part having an opening used to center and attach the wheel to the vehicle's axle hub, an essentially conical interior riser, another inverted conical part defining, with the interior riser, a rounded tip that has a large radius of curvature, the inverted conical part terminating in a flanged edge designed to join the disk to the rim, characterized in that the stamping device has a tool composed of an essentially cylindrical die and having, in axial cross section, the profile of the flat central part, of the conical interior riser and of the inverted conical part, a cylindrical blank holder having, in axial cross section, the complementary shape of the die and a header die composed in particular of a ring coaxial to the die and to the blank holder and the interior surface of which has a conical laminating part.

The other characteristics of the invention are:

the conical part of the laminating tool has an aperture angle of between 10° and 40°, and preferably 30°;

the conical part of the laminating tool has a die mouth radius of between 8 mm and 20 mm, and preferably 12 mm;

the conical part of the laminating tool has an end-of-die radius of between 2 mm and 20 mm, and preferably 5 mm;

the tool has on its surface a hardening lining selected from among TiN, CrN, IC carbon, non-crystalline carbon, or any other lining suitable for improving the laminating conditions;

the surface of the tool has an Ra roughness of between 0.2 μm and 0.5 μm, and preferably between 0.3 μm and 0.4 μm.

The invention also concerns a motorized land vehicle wheel characterized in that it has a disk the stamped flanged edge of which has a thickness equal to or less than the thickness of the base plate.

The following description and the attached figures, all given by way of non-limiting example, will explain the invention.

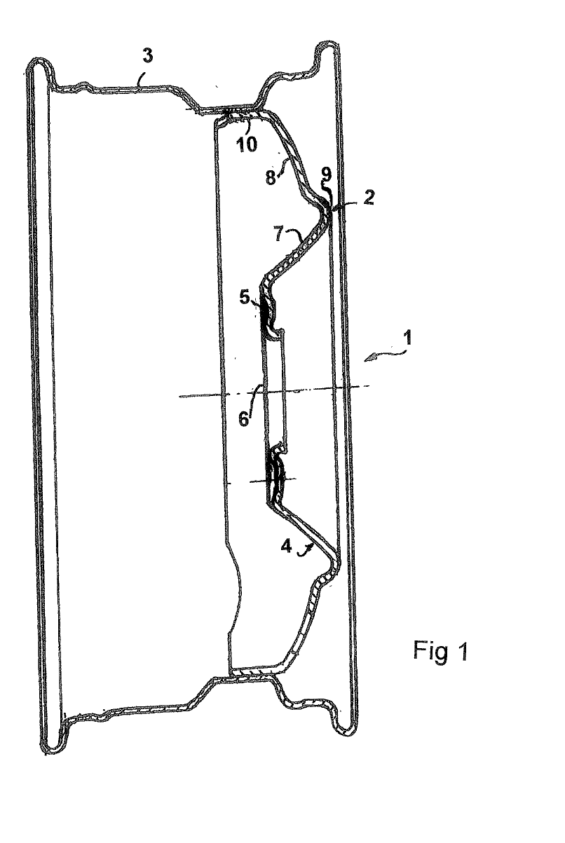

FIG. 1 is a general representation of an automobile wheel according to the invention.

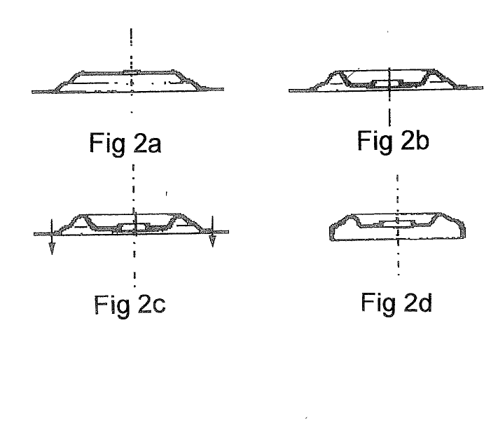

FIGS. 2a, 2b, 2c, and 2d show a series of operations required to produce a wheel according to the invention.

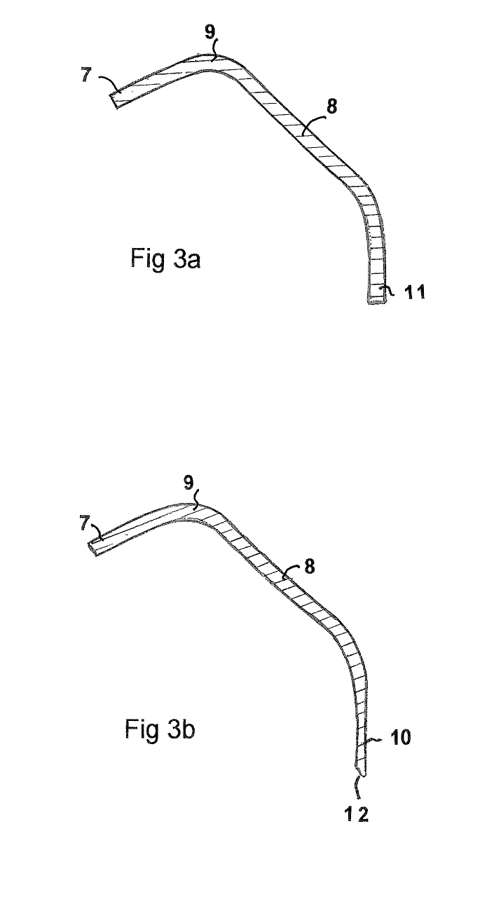

FIGS. 3a and 3b are two axial cross sections of two wheel disks, one of which is standard and one according to the invention.

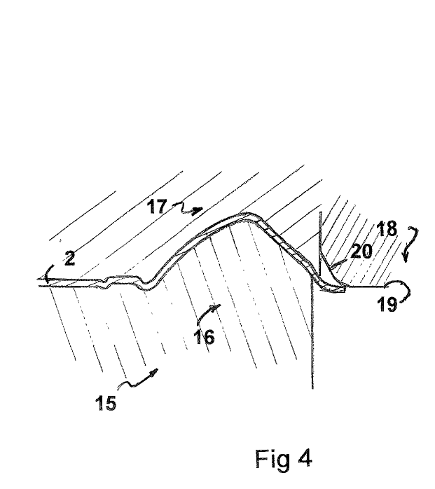

FIG. 4 is a schematic diagram depicting the forming of the wheel disk according to the invention, on the stamping tool according to the invention.

The process according to the invention concerns the production of a motorized land vehicle wheel 1, in general having a wheel disk 2 and an essentially cylindrical rim 3, the wheel disk 2 being obtained from a blank plate 4 of specific thickness subjected in particular to various shaping operations, and composed of an essentially flat central part 5 having an opening 6 used to center and attach the wheel 1 to the vehicle's axle hub, an essentially conical interior riser 7, another inverted conical part 8 defining, with the interior riser 7, a rounded tip 9 that has a large radius of curvature, the inverted conical part 8 terminating in a flanged edge 10 designed to join the disk 2 to the rim 3. According to the invention, during the operation to form the flanged edge 10, the blank plate 4 is laminated around the whole periphery of the disk 2 in order to preserve the thickness of the plate if it is optimized, or to reduce the thickness of the base plate in order to optimize the mechanical characteristics of said wheel 1.

The problem resolved in particular is that of providing just the right thickness for the flanged edge. A reduction of thickness in this area allows the inside diameter of the disk to be increased.

An advantage of the proposed solution is the decrease in the thickness of the wheel disk in the area of the flanged edge. This decrease in thickness is accomplished during the flanged edge operation, included in the stamping as represented in FIGS. 2a, 2b, 2c, 2d. The operation consists in laminating the blank plate during the flanged edge operation.

The first stamping operations, diagrammed in FIGS. 2a, 2b, 2c, are standard. FIG. 2a represents a first stamping operation to form the interior riser 7, FIG. 2b represents a second stamping operation to form the inverted conical part 8, FIG. 2c shows the operation of cutting the periphery of the wheel disk before stamping the flanged edge 10, and FIG. 2d shows the wheel disk after formation of the flanged edge 10. At the end of the laminating operation of the flanged edge 10, the periphery of the blank is cut off. The diameter of the cut can be reduced to accommodate the overlength caused by the laminating operation.

FIG. 3a shows an image of part of a vehicle wheel in axial cross section produced in the standard manner, and FIG. 3b shows the same wheel part produced according to the invention. In the standard method of forming, the part 11 of the blank plate used to form the flanged edge is contracted, thus necessarily causing an increase in the thickness of the blank plate. According to the invention, the forming by lamination of the portion of the blank plate to be used to form the flanged edge 10 is subject to a forced drawing, generating an elongation of the formed part; the drawing can either preserve the thickness of the base blank plate, or if needed, reduce the thickness of the blank plate in a constant or progressive manner.

In this same laminating operation, the final edge 12 of the periphery of the laminated part can be beveled instead of straight.

The laminating of the part of the blank used for the flanged edge can be done with or without scalloping, depending on the diameter of cut chosen following the laminating operation of the flanged edge. The presence of scalloping is not prohibitive. It should be noted that this technique requires more press power than what is used for the standard flanged edge operation.

According to the invention, the flanged edge laminating operation requires suitable tooling.

As shown in FIG. 4, the tool 15 of the stamping device for motorized land vehicle wheel disk 2 is composed of an essentially cylindrical die 16 having, in axial cross section, the profile of the disk, i.e., the profile of the essentially flat central part, of the essentially conical interior riser and of the conical part, a cylindrical blank holder 17 having, in axial cross section, the complementary shape of the die 16 and a header die 18 composed in particular of a ring 19 coaxial to the die 16 and to the blank holder 17 and the interior surface of which has a conical laminating part 20.

the conical part of the laminating tool has an aperture angle of between 10° and 40°, and preferably 30°,

the conical part of the laminating tool has a die mouth radius of between 8 mm and 20 mm, and preferably 12 mm;

the conical part of the laminating tool has an end-of-die radius of between 2 mm and 20 mm, and preferably 5 mm;

the tool has on its surface a hardening lining selected from among TiN, CrN, IC carbon, non-crystalline carbon, or any other lining suited to improving the laminating conditions;

the surface of the tool has an Ra roughness of between 0.2 μm and 0.5 μm, and preferably between 0.3 μm and 0.4 μm.

The geometry of the tool 15 is suited for the laminating operation as well as for reducing to the desired thickness. The final thickness of the flanged edge is directly related to the gap between the header die 18 and the die 16.

In effect, the size of the tool 15 must be able to withstand heavy loads, and must also resist frictional forces.

In one example of application the header die 18 has a female cone with an aperture angle 21 of 30°, a die mouth radius 22 of 15 mm and an end-of-die radius 23, laminating radius, of 20 mm.

The lining of the tool 15 is important. It determines the value of die header load, lateral loads, stripping, and whether or not wear and sticking phenomena occur. A lining of TiN, CrN, IC carbon or non-crystalline carbon is advised.

The roughness is important to allow better trapping of the oil. An Ra on the order of 0.3 μm or 0.4 μm in the example seems optimal.

According to the forming procedure used, an additional circular cutting operation may be necessary. This cut can also be used to scallop the flanged edge in the areas that will not be used to weld the disk to the rim.

The final reduction in weight of the wheel according to the invention is about 0.3 kg for a 15-inch wheel disk.

Variations of embodiment concern the position of the cut, in the process of producing the wheel, to cut the flanged edge to length. This cut can be made prior to the flanged edge operation or at the end using a cam cut if it is done on the press line, or by using a cut-off tool.

1. Process for producing a motorized land vehicle wheel having, in general, a wheel disk and an essentially cylindrical rim, the wheel disk being obtained from a blank plate of specific thickness subjected to several forming operations, and composed of an essentially flat central part having an opening used to center and attach the wheel to the vehicle's axle hub, an essentially conical interior riser, another inverted conical part defining, with the interior riser, a rounded tip that has a large radius of curvature, the inverted conical part terminating in a flanged edge designed to join the wheel with the rim, which process is characterized in that during the operation of forming the flanged edge, the plate is laminated in such a way as to preserve or reduce the thickness of the base plate.

2. Process according to claim 1, characterized in that the plate is laminated by stamping.

3. Process according to claim 1, characterized in that the periphery of the disk is first cut to a smaller diameter in order to accommodate the overlength caused by the laminating operation, during the operation to form the flanged edge.

4. Stamping device for motorized land vehicle wheel disk, the wheel disk being obtained from a blank plate of specific thickness subjected to several forming operations, and composed of an essentially flat central part having an opening used to center and attach the wheel to the vehicle's axle hub, an essentially conical interior riser, another inverted conical part defining, with the interior riser, a rounded tip that has a large radius of curvature, the inverted conical part terminating in a flanged edge designed to join the wheel with the rim, characterized in that the stamping device has a tool composed of an essentially cylindrical die in axial cross section, the profile of the flat central part, of the conical interior riser and of the inverted conical part, a cylindrical blank holder having, in axial cross section, the complementary shape of the die and a header die composed in particular of a ring coaxial to the die and to the blank holder and the interior surface of which has a conical laminating part.

5. Device according to claim 4, characterized in that the conical part of the laminating tool has an aperture angle of between 10° and 40°, and preferably 30°.

6. Device according to claim 4, characterized in that the conical part of the laminating tool has a die mouth radius of between 8 mm and 20 mm, and preferably 12 mm.

7. Device according to claim 4, characterized in that the conical part of the laminating tool has an end-of-die radius of between 2 mm and 20 mm, and preferably 5 mm.

8. Device according to claim 4, characterized in that the tool has on its surface a hardening lining selected from among TiN, CrN, IC carbon, non-crystalline carbon.

9. Device according to claim 4, characterized in that the surface of the tool has an Ra roughness of between 0.2 μm and 0.5 μm, and preferably between 0.3 μm and 0.4 μm.

10. Motorized land vehicle wheel characterized in that it has a disk the stamped flanged edge of which has a thickness equal to or less than the thickness of the base plate.
